(19) United States
(12) Patent Application Publication
(10) Pub. No.: US 2004/0128619 A1
(43) Pub. Date: Jul. 1, 2004

(54) System and method for enhancing customer relationships by providing E-interaction aids within a story

(76) Inventor: Ralph McCall, Huemoz (CH)

Correspondence Address: MOETTELI & ASSOCIES SARL, CASE POSTALE 486, AVE DE FRONTENEX 6, GEVEVA 12, CH-1211, CH

(21) Appl. No.: 10/729,946

(22) Filed: Dec. 9, 2003

Related U.S. Application Data
(60) Provisional application No. 60/436,488, filed on Dec. 26, 2002.

(51) Int. Cl. G06F 17/00

(52) U.S. Cl. 715/513

(57) ABSTRACT

A system and method develops customer relationships with readers/viewers of a media for relating a story. The story has a title, a body, an end, and dramatically created points of interest interspersed throughout the body. The system includes the media, a media storage device, the media being stored therein, and a customer relationship management module (CRMM). The media has at least one contact aid encoded in the body of the story proximate a point of interest. Upon a user selection, the contact aid aids in establishing a channel of communication from which the reader/viewer can interact with the CRMM regarding the point of interest. The CRMM captures information about the reader/viewer and analyzes the captured information, serving up appropriate portions of supplemental data to the reader/viewer. The contact aid is associated with an author or a character of the story.

### BACKGROUND OF THE INVENTION

This invention relates to Customer Relationship Management (CRM) and, more particularly, to methods and systems for strengthening customer loyalty.

CRM is an information industry term for systems (methodologies, software, and usually Internet capabilities) that help an enterprise manage customer relationships in an organized way. For example, an enterprise might build a database about its customers that described relationships in sufficient detail so that management, salespeople, people providing service, and perhaps the customer directly, can access information, match customer needs with product plans and offerings, remind customers of service requirements and know what other products a customer had purchased, among other things. Building customer loyalty is a key objective of CRM (see http://www.crm-forum.com for further details.).

Customer loyalty and value analytics are fundamental to CRM. Based on a CRM study of IT executives conducted in 2002, the Gartner Group ranked customer loyalty second only to creating a single view of the customer: Building customer loyalty is an essential component of CRM, with long-term sales and marketing as key objectives. Therefore, CRM is a technology-enabled business strategy that helps leverage ‘customer knowledge’ to build up profitable customer relationships. A key outcome is ‘increased profitability’ through a number of initiatives which either increase the ‘customer base through acquisition or retention’ or cost reduction through effectiveness and efficiency of sales and marketing programs.

CRM involves the implementation of business strategies in software modules that identify and manage customers to derive maximum long-term value from that relationship. The adoption of CRM requires a customer-centric business philosophy that is often a change from the traditional product oriented nature of many businesses (See, for example, http://www.it-director.com for further information).

Contact between business and customer can take place in a variety of ways and historically, each route into the business, or interaction point has been handled by different people in different ways. Most often, companies attempt to use CRM software to create a database or an integrated set of databases to hold customer data. The purpose is to provide a single and consistent view of the customer for the whole business so that the information exchanged and the ongoing dialog is stored in a central location and hence available to all members of a business i.e. Sales, Marketing, Support, Accounts and Management. The data held in the customer databases is captured through a variety of means, including web and email, call centers, a direct sales force, channel partners, and retailing.

CRM previously focused on the telephone as the primary means of contact, with little attention paid to e-mail or the Web. However, electronic messaging is overtaking voice as the most common form of communication. Although electronic messaging is not likely to ever completely replace voice, this change requires that personnel be trained and equipment be put into place to manage e-mail and Internet inquiries.

The three primary areas that CRM systems focus on are sales, customer service and marketing automation.

Sales, also called sales force automation, includes five principal areas: field sales, call center telephone sales, third-party brokers and related distributors or agents, retail, and e-commerce, which is sometimes referred to as technology-enabled selling.

Customer service and support encompasses the following:

Field service and dispatch technicians,

Internet-based service or self-service via a Web site,

Call centers that handle all channels of customer contact, not just voice.

Marketing automation differs from the other two categories because it doesn't involve customer contact. It focuses on analyzing and automating marketing processes. Marketing automation products include the following:

Data-cleansing tools,

Data analysis or business intelligence tools for ad hoc querying, reporting and analyzing customer information, plus a data warehouse or data mart to support strategic decisions,

Content-management applications that allow a company's employees to view and access business rules for marketing to customers,

A campaign management system, which is a database management tool used by marketers to design campaigns and track their impact on various customer segments over time.

Depending on a company's goals, the tools it chooses would be integrated across the main areas of sales, service and marketing. The technology includes databases, data warehouses, servers and other hardware, telephony systems, software for business intelligence, workflow management and e-commerce, middleware and system administration management tools.

CRM focuses on building and maintaining customer relationships and their loyalty. Therefore, CRM systems propose to achieve this by performing the following tasks:

Updating customers with event, promotion or sales information

Informing customers of service interruptions or other issues as they are happening

Preventing customers from seeking out competitive offers because of minor product or service problems

Sending out notices about critical company announcements before they affect customers

Reassuring customers when service will resume and answer all pertinent questions

Issuing periodic payment reminders or any other reminders that require high communications volumes

Using target announcements to drive cross-sell and up-sell activities

Increasing sales through tailored, personalized communication.

Blurring the line between sales, marketing and operations.

Besides sales and marketing activities, CRM systems are often tied to back-office systems such as order-fulfillment, contract management, billing and accounting.

One predominant CRM strategy is to develop User Communities. The CRM system produces a forum that allows customers to engage in dialogue with the company and with other Reader/viewers, to express their views on products, to share experience and opinions. CRM systems also provide communications tools for virtual meetings, live training, conferencing and moderated events. Specialized features include:

Chat: to communicate in real-time, create room, group peers and join moderated events.

Forums: Post, reply and attach files or public password-protected interactive discussion boards.

Web Tours: For specialized training and marketing purposes, to push web pages to Reader/viewers or lead them to a site-to-site online tour.

Many prior art systems automatically handle individualized customer communications with system-generated replies, whether it is the automatic answer to a technical question, training quizzes, or information seeking. Some systems involve support tools where humans in contact centers interact with customers over the telephone and then through email, or where an automated email response is first sent to the customer, then the escalation goes to human assisted email response, to a human voice interaction.

While there is a move toward automated self-service, maintaining contact center agents is a significant aspect of customer service due to the critical importance of customer relationships to a company. To increase customer loyalty and retention, it has been recognized that social networks play a significant role in the process. Therefore, it is unlikely that contact agents will become obsolete, as customers prefer human interaction.

CRM is a strategy implemented by a technical process and is designed in such a way that it can comprehend and predict the needs of the current and potential customer base a company has. CRM strategy includes a principal that first, customer recognition, and then, relationship building, are essential to enhancing customer relationship management, the latter necessitating a knowledge of a customer's product preferences, budget, and shopping habits. Such knowledge can enable online retailers to up-sell and cross-sell, supply personalized information and information services and closely target advertising. The Internet becomes the main route for personalization

The first step in this process is customer recognition, during which basic information on the customer, such as name and email address, is captured. Then, an attempt is made to learn the preferences of the customer. Many retail companies begin this data capture through such tools as fill-in and return warranty cards, or registering customers into loyalty programs.

The problem with which companies are faced, including various types of media companies, is capturing the initial data. This is compounded by the question of how to understand the preferences of the customer and develop a relationship with the customer. Certain industry sectors are very deficient in the customer data capture process, chief among these being publishing companies that learn almost nothing about the customers who buy a book at the local bookstore. Even if the bookstore is able to capture customer information, this information is not likely to be transmitted to the publisher, and even less likely to the author. Therefore, publishers and, more particularly, authors have difficulty in truly understanding who their reader base is, or what the reader base is thinking. On-line bookstores are an exception in some ways in that they keep database records of the buying patterns of their customers. This, however, is usually limited to adware and cookies which monitor customer purchases and then develop a profile of the customer in an effort to predict his tastes and to match these tastes with product most likely to interest him. Similarly, cinema and television companies generally are unable to capture information about their customers. To obtain this User information can involve costly surveys or the collection and processing of User completed forms.

The customer loyalty sought to be developed by CRM systems is achieved through many means, such as timely and accurate responses to customer requests and demands. Foremost, loyalty is achieved through the relationship developed through the use of technical tools together with human interaction.

Further, Authors of books and films create and are themselves interesting characters with which certain reader/viewers can readily identify and may wish to communicate. This is particularly true in the case of suspenseful plots or thrillers that often leave the reader/viewer hanging, unable to learn more about the story just when the interest is most intense.

What is needed therefore is a system and a method to build customer loyalty through the capture, processing and interpretations of customer information, including customer tastes, budgets and buying habits. Further, what is needed is a system and method for building customer loyalty in the book publishing and film industries. In particular, what is needed is a system and method that enables such a traditional media company to build loyalty with their customers by capturing the customer's email address, allowing personal interaction with the customer, satisfying the reader/viewer's curiosity at a moment when it is most intense, and personalizing the experience of the reader/viewer with the story, thereby enhancing the customer's affinity toward the product and company.

### SUMMARY OF THE INVENTION

The system and method is provided which meets the needs identified above by providing a means of developing customer relationships with readers/viewers of a media for relating a story having a title, a body, an end, and dramatically created points of interest interspersed throughout the body. The system includes the media, a media storage device, the media being stored therein, and a customer relationship management module (CRMM). The media has at least one contact aid encoded in the body of the story proximate a point of interest. Upon a user selection, the contact aid aids in establishing a channel of communication from which the reader/viewer can interact with the CRMM regarding the point of interest. The CRMM captures information about the reader/viewer and analyzes the captured information, serving up appropriate portions of supplemental data to the reader/viewer. The contact aid is associated with an author or a character of the story.

The system and method provides a systematic process for book publishing and film companies to develop relationships with their Reader/viewers. The invention recognizes that authors in traditional media create situations of high interest, and then takes advantage of these otherwise lost opportunities to cater to the desires of the Reader/viewer by providing him or her a means to communicate with the author or fictitious character, thus bring him or her into the story and customizing the reading/viewing experience to the user's needs. E-interaction points are provided to enable the system to respond to user questions about the subject matter of the story, or to obtain updates about the story particularly in open-ended plots, such as found in soap operas. In addition, these e-interaction points enable Reader/viewers who so desire to express their feelings or give advice on what a particular Character might do in their situation, but have had traditionally no means of doing this.

The system and method of the invention thus enables a company to capture the customer's email address and allow personal interaction with the customer by means of these e-interaction points, such as by an email address of a character from the story embedded within the plot of the story or chatrooms having entry points within the story. These mechanisms thus facilitate the customer's affinity toward the product and company.

### BRIEF DESCRIPTIONS OF THE DRAWINGS

The accompanying drawings, which are incorporated in and constitute a part of this specification, illustrate an implementation of the invention and, together with the description, explain the advantages and principles of the invention.

FIG. 1 is a schematic diagram of the system of the invention.

FIG. 2 is a perspective view of a media of the system of the invention.

FIG. 3 is a block diagram showing an overview of the system and method for enhancing customer relationships by providing E-interaction points within a story.

FIG. 4 is a flowchart of the process of identifying and embedding E-interaction points within a story.

FIG. 5A is a flowchart of the interaction between a Reader/viewer with embedded E-interaction points within a story.

FIG. 5B is a flowchart of the processing of a User's response message in the customer loyalty system of the invention.

FIG. 5C is a flowchart of the processing of a User's on-going communications handling in the customer loyalty system of the invention.

FIG. 5D is a flowchart showing the initiation of the marketing program by the customer loyalty system of the invention.

### DETAILED DESCRIPTION OF THE INVENTION

The method of the invention comprises two main components which are interconnected. These components are (1) stories in traditional or electronic media (specifically; books, journals, magazines, newspapers, cinema, television, stage-play, the Internet); and (2) a marketing system, typically, a Customer Relations Management Module (“CRMM”), directed toward developing relationships with readers/viewers. The stories in traditional or electronic media are stories published in books, journals, magazines, newspapers, cinema, television, films, stage-play, the Internet or any other form of media. These stories contain human or nonhuman real and fictitious characters. Typically, the story involves one or more of the following:

compelling plot that opens questions (moral, social, political, economic, etc.)

A plot that requires further resolution

Strong action in international settings

Compelling personal relationships

A profound dilemma that engages the reader (moral, economic, political)

This kind of plot compels the user (readers/viewers, including spectators, web surfers) to follow the story, to find out what is happening with the character, and even provide input through the ‘virtual’ dialogue that will occur via the email addresses and/or websites of the character(s) contained within the story. The readers/viewers are individuals who read or view the story. The Reader/viewer sees the email addresses or websites in the story and is motivated to send an email message to the character.

The CRMM includes a website or sites linked to the characters, containing email addresses of the characters. When the CRMM receives a message from a Reader/viewer, this is analyzed by a processor to determine an appropriate reply, which is subsequently served up by a server. There may also be direct human intervention in preparing and sending the reply. An ongoing dialogue may be carried out between the character and the Reader/viewer. The email address and correspondence with the Reader/viewer will be held in a database. At appropriate times, marketing messages will be sent to the Reader/viewer.

To further develop the involvement of the Reader/viewer, a chat room is available within the Marketing System. This is a place where the Reader/viewer may communicate with other Reader/viewers to discuss the story.

Reference will now be made in detail to the implementation of the present invention illustrated in the accompanying drawings. Wherever possible, the same reference numbers will be used throughout the drawings and the following description to refer to the same or like parts.

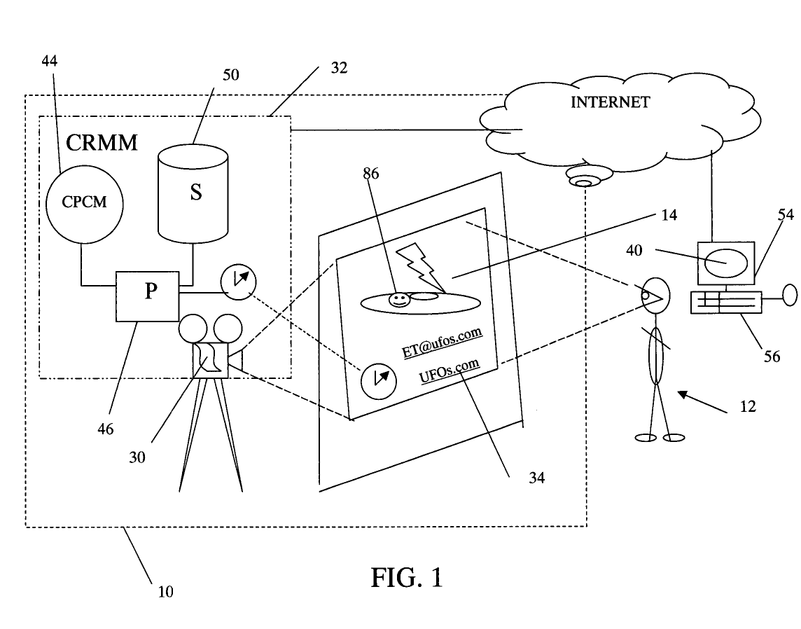

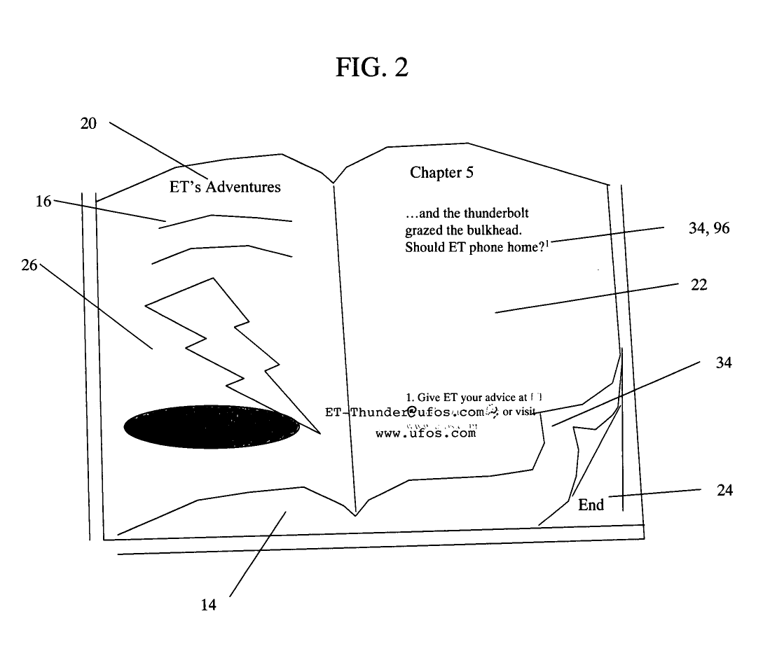

Referring to FIGS. 1 and 2, a system 10 is provided for developing customer relationships with readers/viewers 12 of a media 14 for relating a story 16 having a title 20, a body 22, an end 24, and dramatically created points of interest 26 interspersed throughout the body. The system 10 includes the media 14, a media storage device 30, the media being stored therein, and a customer relationship management module (CRMM) 32. The media 14 has at least one contact aid (E-interaction aid) 34 encoded in the body 22 of the story 16 proximate a point of interest 26. Upon a user selection, the contact aid 34 aids in establishing a channel of communication 36 from which the reader/viewer 12 can interact with the CRMM 32 regarding the point of interest 26. The CRMM 32 captures information about the reader/viewer 12 and analyzing the captured information, serving up appropriate portions of supplemental data 40 to the reader/viewer. The contact aid 34 is associated with an author or a character 42 of the story 16.

The contact mechanism 34 can be a character-specific postal address, telephone number, email, SMS, chat room address, IP address, web page address, activatable mailto hyperlink and hypertext link to a URL.

Note that if the contact aid 32 above is an email address 96, the email address is preferably tagged to be easily, automatically identified with the particular interaction point proximate which it is found (e.g., ET-Thunder@ufos.com, in which the “thunder” tag directly in the email address, enables a rule in email routing software in a marketing system to route the email to the appropriate person or mechanism/module equipped to answer questions about the interaction point.

Although preferably an email address, the contact mechanism 34 can also be a character-specific postal address, telephone number, SMS, chat room address, IP address, web page address, activatable mailto hyperlink and hypertext link to a URL.

The CRMM 32 comprises at least a customer profile capture module (CPCM) 44 for capturing information about the reader/viewer 12, a processor 46 which analyses the captured information and identifies supplemental data 40 of potential interest to the reader/viewer, and an intelligent server 50 which serves up the supplemental data 40 to the reader/viewer 12. A supplemental database 50 is optionally directly connected to the media storage device 30 via the e-interaction points and on which the supplemental data is stored for retrieval by the intelligent server.

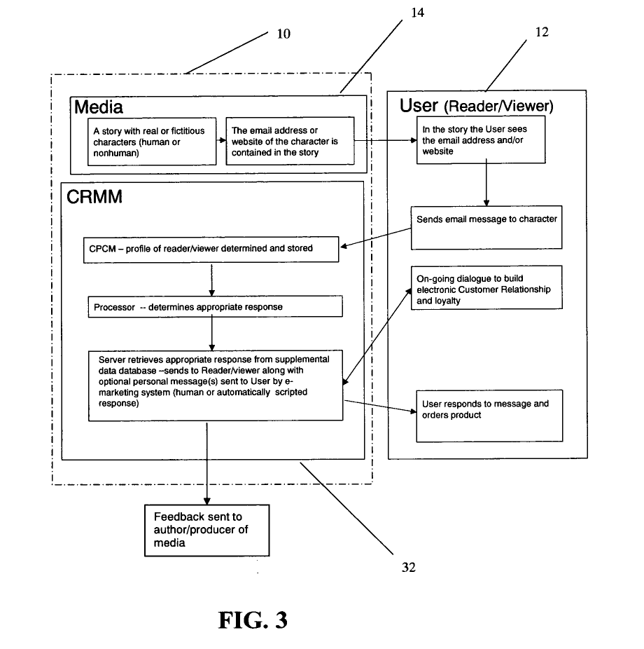

Referring now to FIG. 3, a block diagram is provided, showing an overview of the system 10 and method of the invention. A channel of communications 36 is opened up between the Reader/viewer 12 and the CRMM 32 with the aid of the media 14, once the reader/viewer recognizes and activates the contact aid 34 after being encouraged to do so due to the interest generated at that particular point 26 in the story 16. Further, once the reader/viewer 12 responds, his response and certain personal details are stored in the CPCM 44. Thus, a connection between the Reader/viewer 12 and an e-marketing system may be established. An appropriate e-marketing system incorporating CRM functionality suitable for this purpose E.PHIPANY™ available from Siebel Systems, Inc of San Mateo, Calif. (technical information concerning both systems is attached as Exhibit A and incorporated herein by reference).

The system 10 and method use many standard components such as conventional computers 54, telecommunications services, and input/output devices such as keyboards 56 and printers.

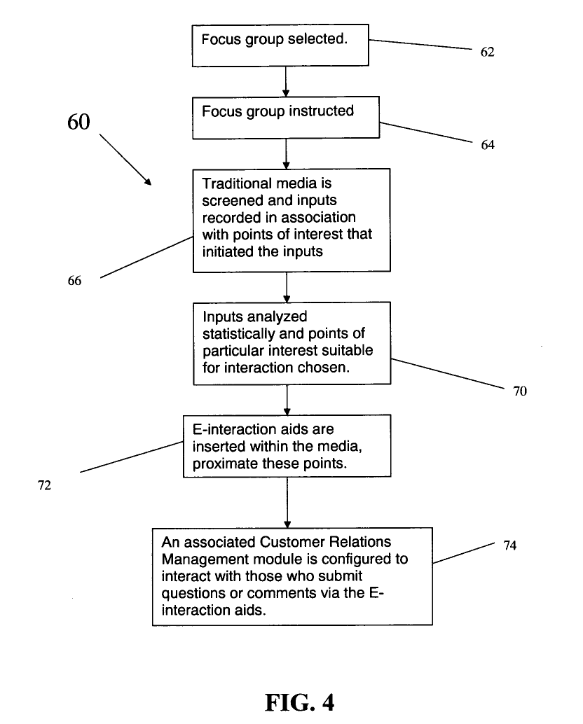

A precursor process 60 (shown in FIG. 4) determines appropriate E-interaction points within a story. This process 60 involves the steps of playing the media 14, during which playing reader/viewer comments and questions are solicited contemporaneously with the playing of the media. The comments and questions of the readers/viewers are analyzed in association with the passage or point of interest 26 within the media 14. Thus, the points of interest 26 in which to insert E-interaction aids are determined.

In order to implement this process 60, an E-interaction point ID system (not shown) is used. The ID system includes a traditional media player, a presentation area such as a cinema, and an interaction device by which, during the playing of the traditional media, enables the focus group member to register the point in the media, and to record questions or comments, optionally pausing the action. A representative interaction device includes a microphone connected to a recording device, the microphone being activated by the focus group member pressing on a button thereby activating both a recording device for recording the comment and a bookmark indicator for registering the frames or point in the media to be associated with the comments or question, this information being recorded in association with the comment or question. Optionally, pressing the button freezes the frame and pauses the action as with a typical remote control device. In the case of a book, the book is read aloud and the comments of the reader/viewer may be recorded in a separate track adjacent the recording of the passage read, in order to properly associate the comments of the reader with the passage.

Referring now to FIG. 4, the process 60 of determining where to insert E-interaction points includes five steps. In a first step, 62, a focus group of representative viewers/readers is selected. In a second step 64, the focus group is instructed regarding the operation of the systems and the purpose of the screening. Specifically, they are told that they are to screen a media, and will be provided with an interaction means by which, during the playing of the traditional media, they can ask a question or record a comment, optionally pausing the action. A feedback device is provided, such as a tape recorder and microphone adjacent the seat of the viewer/reader by which he or she may contemporaneously record a thought or ask a question. In a third step 66, the traditional media is screened by a focus group of representative viewers/readers, during which viewing, the reader/viewer interacts by inputting questions or comments at particular points of interest during the playing of the media. In a fourth step 70, the comments and/or questions are analyzed and, based on statistical analysis, the points of particular interest suitable for interaction are chosen. In a fifth step 72, E-interaction aids are inserted within the media 14, proximate these points 26. In a fifth step 74, an CRMM 32 is configured to interact with those who submit questions or comments via the E-interaction aids 34. The questions asked during the focus group session provide a guide to the CRMM 32 as to what sorts of questions or comments can be expected when the media 14 is played to a mass audience. Standard responses to these questions are then prepared and saved so as to be retrievable by the system 10 when similar questions are asked during the mass playing of the media 14.

Various traditional forms of media 14 may be used for the invention, including books, journals, cinema, television, the internet, and ail other media methods employed for presenting stories to readers/viewers.

In an alternate embodiment, the process 60 includes a means of asking interesting questions to the Reader/viewer in the form of subtitles or teletext to compel the reader/viewer to think and to direct their thoughts with a goal of encouraging the reader/viewer to contact a character through the email address or website.

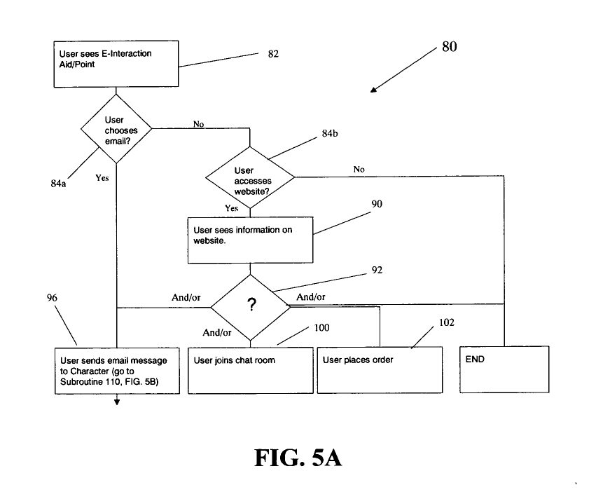

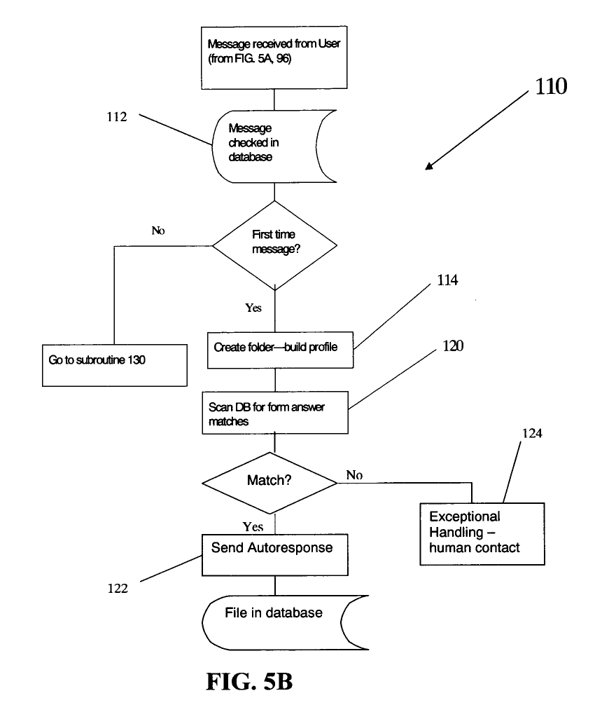

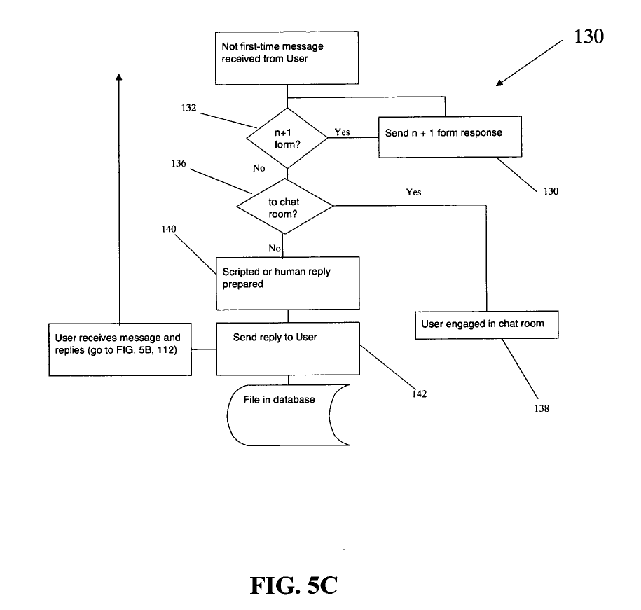

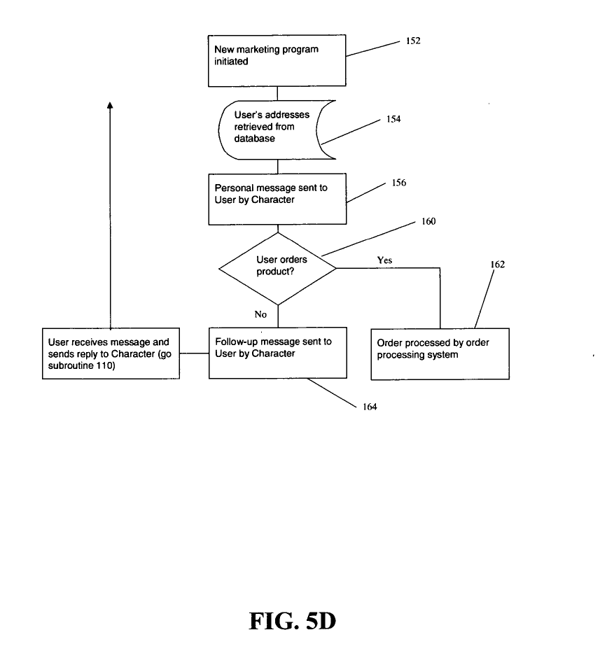

Referring now to FIGS. 5A-5D, the Customer Relations Management Module (CRMM) 32 interacts with the reader/viewer 12 to build customer loyalty. The CRMM 32 is comprised of several subroutines or workflow processes which handle the reader/viewer's response or inquiry, profile the reader/viewer, and initiate a marketing plan to present the reader/viewer with products and services likely to be of interest to the reader/viewer.

Referring in particular to FIG. 5A, a subroutine 80 processes a User's response to embedded E-interaction aids 34 within a story 16. In a first step 82, a Reader/viewer 12 will view or read the story 16 and see the E-Interaction aids 34. In a second step 84, upon seeing the E-Interaction aid 34 in the story 16, the Reader/viewer 12 may choose between contact options. A first alternate step 84a, the reader/viewer 12 chooses to send an email, in which the Reader/viewer sends an email message to the Character 86 (shown in FIG. 1). In a second alternate step 84b, the reader/viewer 12 chooses to access a website (not shown) associated with a character 86. Subsequently, in a first substep 90, the Reader/viewer 12 sees information pertaining to the Character 86 and/or the story 16. In a second substep 92, the Reader/viewer 12 chooses among a set of actions, including substep 96, sending an email message to the Character 86, substep 100, joining a chat room where the Reader/viewer may engage in discussion with the Character and with other Reader/viewers, and/or substep 102, placing an order for a product presented at the website. Preferably, an order processing system (not shown) may be linked to the website, or there may be a hyperlink to another site where the order processing would take place. If the Reader/viewer 12 does not decide to contact the Character 86 by email 96 or access the website (in step 84b), then the process terminates.

Referring in particular to FIG. 5B, a message processing subroutine 110 processes the Reader/viewer's response message in such a manner as to build customer loyalty. Preferably, the subroutine 110 is a combination of electronic data processing and human intervention. Once an email message is received, in a first step 112, the subroutine 110 checks the email against a database that stores all previous email messages sent by Reader/viewers 12 and the Character 86, as well as a checking against email addresses. In a second step 114, if no email matches are found in the database, then the message is flagged as a first message and a folder for storing messages is created for the new Reader/viewer 12. Optionally, the Customer Profile Capture Module asks questions of the reader/viewer to build a customer profile which can be later accessed to initiate a marketing program directed at the reader/viewer. In a fourth step 120, a database of standard words and phrases is scanned to determine whether there is a match. In a fifth step 122, if there is a match, then an automated response is sent to the Reader/viewer by selecting from a set of pre-defined scripts. In a sixth step 124, if there is no standard match, then the message will go to a contact center where human intervention takes place and a response given. The contact center monitors the quality of responses to the Reader/viewers 12 from this automated process to ensure the Reader/viewer feels they are receiving a personalized response. In a seventh step 126, the resulting correspondence is saved in the user-specific folder created in step 116 and stored in a database for later reference.

Referring again to the fifth step 122, scripts will include such topics as, the Character giving information about developments in his/her life, information on the development of the story, and questions to the Reader/viewer asking their thoughts or advice. These responses are designed to generate a feeling of personal involvement with the Character.

Referring in particular to FIG. 5C, an on-going communications subroutine 130 processes the Reader/viewer's on-going communications. If the system check in subroutine 110 determines it is not the first time communication from the Reader/viewer 12, then, in step 132, the system checks to see whether all potentially pertinent autoresponses have been sent to the Reader/viewer. In not, in step 134, a remaining autoresponse is sent to the reader/viewer 12. If so, then in step 136, a scripted message is sent to the Reader/viewer 12 inviting him or her to use a chat room. In step 138, if the reader/viewer chooses to connect with a chat room, a connection is established and the reader/viewer may chat with others having similar interests. In step 140, if the number of communications have not reached the prescribed count to send the Reader/viewer to the chat room, or the contact center feels further back and forth communications are required with the Reader/viewer, then a pre-scripted or human reply is prepared. In step 142, the reply is sent to the Reader/viewer. In step 144, the communications are stored in the system database. The Reader/viewer receives the reply and then may send further communications to the Character 86.

Referring in particular to FIG. 5D, a marketing program initiation subroutine 150 processes user communications by accessing information stored in a Customer Profile Capture Module 44 to determine whether the reader/viewer may be interested in other products or related services. Occassionally, new or related products will be released, such as books and films or sequels thereto. In a first step 152, a marketing program will be defined and initiated. In a second step 154, the Reader/viewer's address will be retrieved from the CPCM 44. In a third step 156, a personalized message is sent to the Reader/viewer 12 by the Character 86 with hyperlinks in the message so that the Reader/viewer is able to order the offered products or services. In step 160, the subroutine awaits a user response. In step 162, if the Reader/viewer 12 decides to order the product or service by, for example, clicking on the hyperlink in the email message, the Reader/viewer is directed to an order processing system (not shown). In alternate step 164, if, after a period of time, the Reader/viewer 12 does not order the product, then the system may optionally generate and send further messages from the Character 86 to the Reader/viewer 12, using various marketing and communication methods to deepen customer loyalty. In this manner, the system 10 and method of the invention implement a comprehensive marketing strategy using traditional media and the Internet as enabling forces to increase the emotional involvement of the customer.

In sum, the invention is a business process implemented in technology using traditional and electronic methods in a manner which enables personalized communications between Reader/viewers 12 and fictional or non-fictional Characters 86 found in fictitious stories in various forms of media. Email address or website URL addresses of Character(s) are placed within fiction stories found in media that lead the Reader/viewer to access the website or send an email message to the Character. An intelligent system composed of configured CRM functionality enables interaction between the Character and the Reader/viewer. The overall process and methods may be broadly categorized as a Customer Loyalty System.

In an advantage, the invention enhances the Reader/viewer's emotional involvement with the characters and/or the story, thereby creating greater customer loyalty while developing a base for further marketing exercises.

In another advantage, by providing a Character-specific email address or website, the readers/viewers are able to communicate with the main character (or authors, producers, publishers, or other persons), to give the character (or other persons) advice regarding the moral dilemma created or to find out what is happening with the story.

In another advantage, the CRMM 32 optionally provides the feedback received by readers/viewers to the writer of the story in order to allow him or her to better understand what the customer base is thinking. Thus, any subsequent novel (or product) can be developed to meet customer expectations, or to confound the customer's expectations in a way that is calculated to yield a desired result.

In another advantage, the CRMM 32 gathers profile information about the readers/viewers, thus providing inputs to an e-marketing tool which will likely reduce the future marketing costs of the author/producer significantly.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A system for developing customer relationships with readers/viewers of a media for relating a story having a title, a body, an end, and dramatically created points of interest interspersed throughout the body, wherein the system comprises:
(a) the media;
(b) a media storage device, the media being stored therein; and
(c) a customer relationship management module (CRMM);
wherein the media has at least one contact aid encoded in the body of the story, proximate a point of interest; wherein, upon a user selection, the contact aid aids in establishing a channel of communication from which the reader/viewer can interact with the customer relationship management module (CRMM) regarding the point of interest, the CRMM capturing information about the reader/viewer and analyzing the captured information, serving up appropriate portions of supplemental data to the reader/viewer;
wherein, the contact mechanism is associated with an author or a character of the story.

2. The system of claim 1, wherein the contact mechanism is selected from a group of contact mechanisms, including a character-specific postal address, telephone number, email, SMS, chat room address, IP address, web page address, activatable mailto hyperlink and hypertext link to a URL.

3. The system of claim 1, wherein the CRMM comprises at least a
customer profile capture module (CPCM) for capturing information about the reader/viewer;
a processor which analyses the captured information, identifying supplemental data in a supplemental database on which the supplemental data is stored; and
a server which serves up the supplemental data to the reader/viewer.

4. A media for relating a story having a title, a body, an end, and dramatically created points of interest interspersed throughout the body, wherein the media comprises at least one contact aid encoded in the body of the story, proximate a point of interest, wherein, upon a user selection, the contact aid aids in establishing a channel of communication from which the reader/viewer can interact with a customer relationship management module (CRMM) regarding the point of interest, the CRMM capturing information about the reader/viewer and analyzing the captured information, serving up appropriate portions of supplemental data to the reader/viewer; wherein, the contact mechanism is associated with an author or a character of the story.

5. The media of claim 4, wherein the contact mechanism is selected from a group of contact mechanisms, including a character-specific postal address, telephone number, email, SMS, chat room address, IP address, web page address, activatable mailto hyperlink and hypertext link to a URL.

6. A method of determining points of insertion of E-interaction points in a media, the method comprised of the steps of:
(a) screening the media in front of at least one test subject instructed to identify points of interest in the media;
(b) soliciting inputs of the at least one test subject in association with points of interest; and
(c) analyzing inputs to identify points of interest suitable for E-interaction points.

7. A method of setting up a Customer Relations Management Module for selling products using E-interaction points in a media, the method comprised of the steps of:
(a) screening the media in front of at least one test subject instructed to identify points of interest in the media;
(b) soliciting inputs of the at least one test subject in association with points of interest;
(c) analyzing inputs to identify points of interest suitable for E-interaction points;
(d) inserting E-interaction points within the media, proximate these points of interest; and
(e) configuring a Customer Relations Management module so as to interact with an anticipated reader/viewer in response to identified needs/interests so as to improve sales of the products.
